(19) United States
(12) Patent Application Publication
(10) Pub. No.: US 2014/0141229 A1
(43) Pub. Date: May 22, 2014

(54) TEXTILE COMPONENT WITH COLLAGEN

(71) Applicant: Hung Yen, New Taipei City (TW)

(72) Inventor: Hung Yen, New Taipei City (TW)

(21) Appl. No.: 13/605,504

(22) Filed: Sep. 6, 2012

(30) Foreign Application Priority Data
Jun. 27, 2012 (TW) 101212368

(51) Int. Cl. B32B 5/02

(52) U.S. Cl. 428/221

(57) ABSTRACT

A textile component with collagen includes a plurality of textile members, wherein the textile member includes a first fiber component and a second fiber component. The first fiber component is composed of a fiber with collagen. The second fiber component has no fiber with collagen. The outer surface of the first fiber component and the outer surface of the second fiber component contact each other along the length direction of the first fiber component by textile spinning. The collagen can be in contact with the skin so as to contribute to the efficacies for, as example, anti-aging, skin-whitening, and wrinkles-eliminating when people wear the textile component.

### FIELD OF THE INVENTION

The present invention relates to a textile component, and more particularly to a textile component with collagen.

### BACKGROUND OF THE INVENTION

Textile clothes is one of article in necessity for human beings. The textile clothes and textile article, such as garment, pants, and sock, helps people to adapt the change of temperature when is used for covering the body, and also prevents us from dusts or germs as well. Textile is an element of the textile article. Textile article is formed by spinning textile.

The material of textile directly decides its functionality and effective application of the textile article. For example, the artificial fiber is advantage in that it is not so expensive, easy washed, and not easy to shrink. However, it is not environmental-friendly, bad water absorption, and bad contact feel. On the other hand, the vegetal fiber is overwhelming in that it is good in absorption and its softness. However it is wrinkly and poor heat resistance. In another aspect, the animal fiber is good in elasticity, heat preservation, shrink resistance, and easy for dyeing, and in the contrary it is too expensive to be used to form a textile.

### SUMMARY OF THE INVENTION

Although the technologists constantly investigate the material of the textile. The focus is rare to the field of textile to improve the effect for the skin of human beings. It should be deeply concerned that some textiles even cause the skin allergy. Further to the effect of textile such as cold resistance, easy washed, water absorption, the invention is effect to improve the health of skin in regard with the textile.

Accordingly, an aspect of the present invention is to provide a textile component with collagen that improves the health of skin.

The textile component with collagen comprises a plurality of textile members, wherein the textile member includes a first fiber component and a second fiber component. The first fiber component is composed of a fiber with collagen. The second fiber component is without any fiber with collagen. The outer surface of the first fiber component and the outer surface of the second fiber component contact each other along the length direction of the first fiber component by textile spinning

According to an embodiment of the present invention, the second fiber component includes an elastic fiber.

According to an embodiment of the present invention, the first fiber component and the second fiber component combine with each other by textile spinning, wherein the proportion between the first fiber component and the second fiber component is 1:1.

According to an embodiment of the present invention, the fiber with collagen includes a collagen and a fiber, the collagen bonds with the fiber at the bonding part of the fiber.

According to an embodiment of the present invention, the collagen bonds with the fiber by dipping the fiber in a collagen solution of which the temperature is 60-70 degrees Celsius and then stirring the collagen solution.

According to an embodiment of the present invention, the first fiber component has 8%-10% collagen thereof.

According to an embodiment of the present invention, the textile member has less than 3% collagen thereof.

According to an embodiment of the present invention, the fiber is a rayon fiber.

By means of technical means of the present invention, the collagen can be in contact with the skin so as to contribute to the efficacies for, as example, anti-aging, skin-whitening, and wrinkles-eliminating when people wear the textile article of the invention. Since the collagen has hydrophilic natural moisturizing factor (NMF) that has good water retentivity for keeping the skin moist, supple, and glossy. And the skin pores can be narrowed and the skin wrinkles can be smoothed out to let skin looks tensely and elastically. Also it can improve the metabolism of skin and provide the skin cell with a more healthy ambience.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a diagrammatic drawing illustrating the textile component of the first embodiment according to the present invention;

FIG. 2 is a diagrammatic drawing illustrating the textile component of the second embodiment according to the present invention;

FIG. 3 is a diagrammatic drawing illustrating the textile component of the third embodiment according to the present invention;

FIG. 4 is a process flow chart illustrating the textile component of the third embodiment according to the present invention;

FIG. 5A is a diagrammatic drawing illustrating the collagen solution;

FIG. 5B is a diagrammatic drawing illustrating the fiber dipping in the collagen solution;

FIG. 5C is a diagrammatic drawing illustrating stirring the collagen solution;

FIG. 5D is a diagrammatic drawing illustrating the first fiber component of the third embodiment according to the present invention;

FIG. 5E is a diagrammatic drawing illustrating the textile member of the third embodiment according to the present invention.

### DETAILED DESCRIPTION OF THE PREFERRED EMBODIMENTS

### The First Embodiment

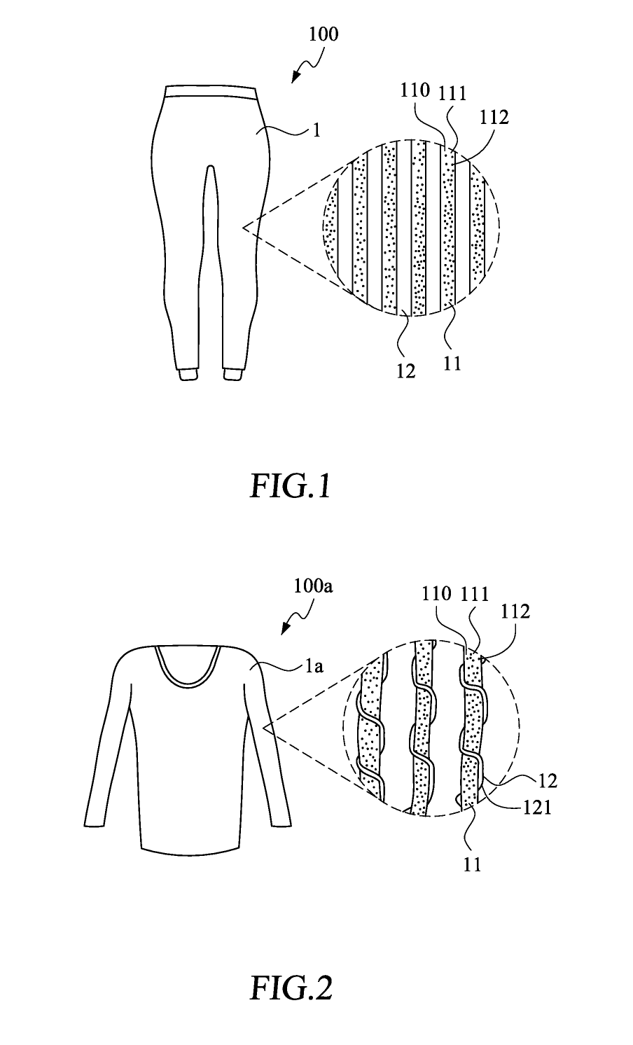

A textile component with collagen 100 of the present invention is shown in FIG. 1. FIG. 1 is a diagrammatic drawing illustrating the textile component of the first embodiment according to the present invention. The textile component with collagen 100 of the present invention comprises a plurality of textile members 1. The textile member 1 comprises: a first fiber component 11 composed of a fiber with collagen 110; and a second fiber component 12 without any fiber with collagen. The outer surface of the first fiber component 11 and the outer surface of the second fiber component 12 contacting each other along the length direction of the first fiber component 11 by textile spinning. The fiber with collagen 110 includes a fiber 111 and a collagen 112. The collagen 112 is a polymeric substance constituting the interstitial matrix between cells and plays a role as a connective tissue in the animal. It can supplement nutrition to the skin and enhance the collagen activity in skin.

In this embodiment, the textile component 100 is a pants, and the textile member 1 is the cloth of the textile component 100. The first fiber component 11 and the second fiber component 12 are the fibers of the textile member 1. Because the first fiber component 11 of the textile component 100 has the collagen 112, the collagen 112 of the first fiber component 11 is in contact with the skin when the users wears the textile component 100, thereby the skin can be moisten by the collagen 112 and thus be good in maintenance.

### The Second Embodiment

Refer to FIG. 2. FIG. 2 is a diagrammatic drawing illustrating the textile component of the second embodiment according to the present invention. The textile component 100a of the second embodiment is different from the textile component 100 of the first embodiment as follows. In this embodiment, the textile component 100a is an upper garment. And the second fiber component 12 of the textile component 100a includes an elastic fiber, such as Lycra fiber. Thereby, the textile component 100a is not easy to be deformed and is fitted and comfortable. And the textile component 100a can easily return to be smooth after being wrinkled. Also the collagen 112 is in contact with the skin more closely so that the maintenance efficacy to the skin is more obvious. In this embodiment, the textile member la is formed by twining the first fiber component 11 and the second fiber component 12 together, wherein the proportion between the first fiber component 11 and the second fiber component 12 is 1:1.

### The Third Embodiment

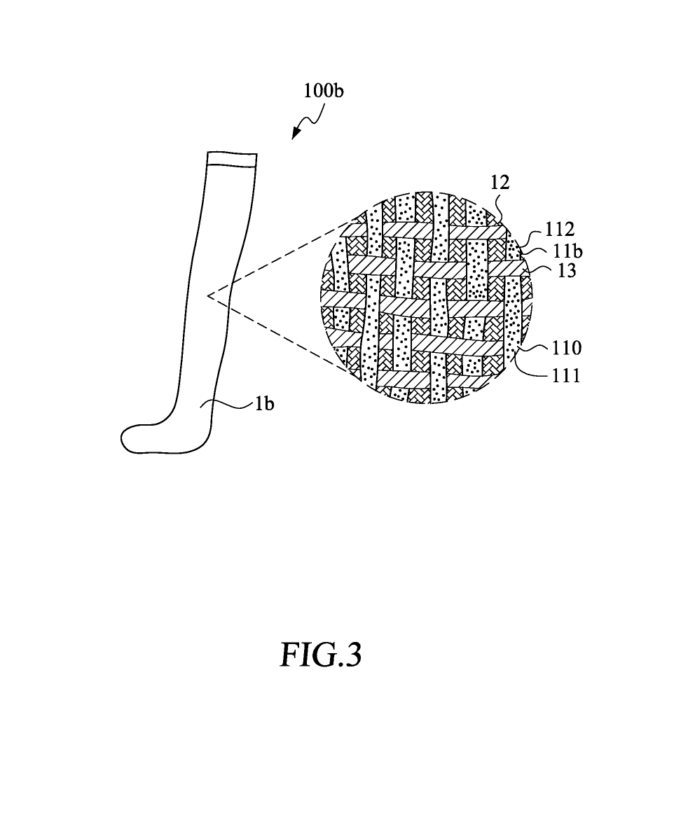

Refer to FIG. 3. FIG. 3 is a diagrammatic drawing illustrating the textile component of the third embodiment according to the present invention. In this embodiment, the textile component 100b is a tights. The textile member lb of the textile component 100b includes the first fiber component 11, the second fiber component 12, and a third fiber component 13. The second fiber component 12 and the third fiber component 13 combine with the first fiber component 11 by textile spinning, wherein the second fiber component 12 and the third fiber component 13 are fiber components without any fiber with collagen.

Because too much collagen will also cause skin allergy, the proportion of the collagen in the clothes is preferably less than 3%. In this embodiment, the proportion (surface area proportion) between the first fiber component 11, the second fiber component 12, and the third fiber component 13 is 20:40:40 in the textile member 1b of the textile component 100b. The first fiber component 11 has 8%-10% collagen 112 thereof, so the textile member 1b has less than 3% collagen 112 thereof. However, the present invention is not limited to that proportion, the proportion between the first fiber component 11, the second fiber component 12, and a third fiber component 13 can be adjusted according to user's requirement.

The fiber 111 and the collagen 112 can be combined with each other by drying, resin molding, or any other methods. In order to make a better combination between the fiber 111 and the collagen 112, the combination method in this embodiment is as follows.

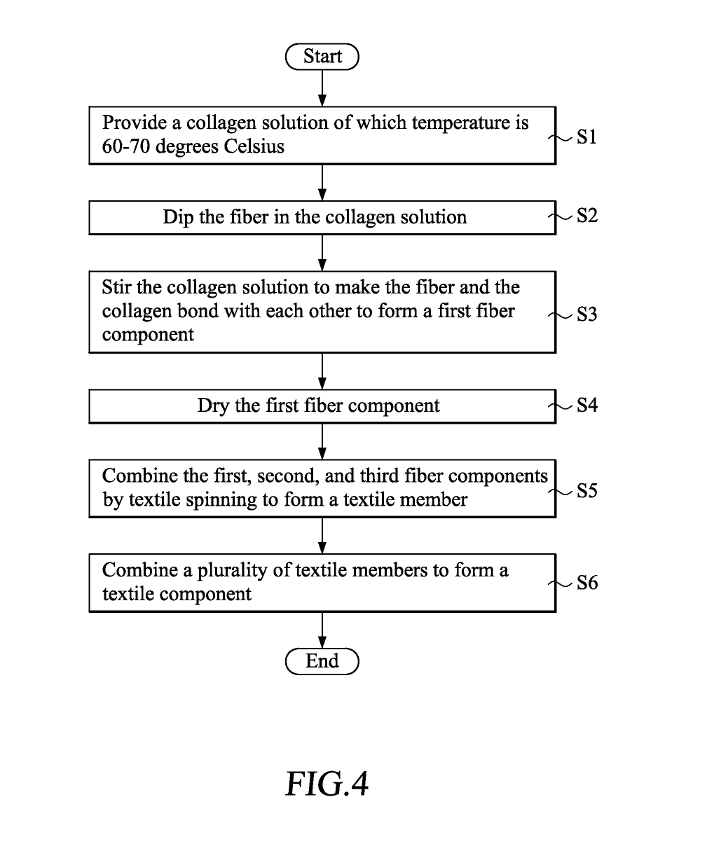

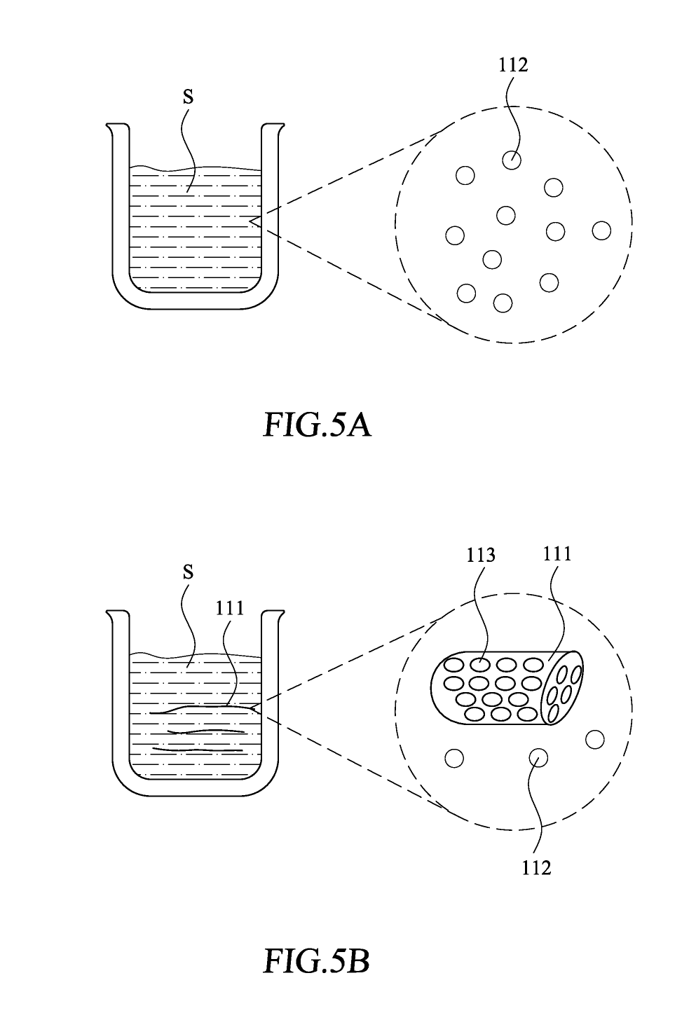

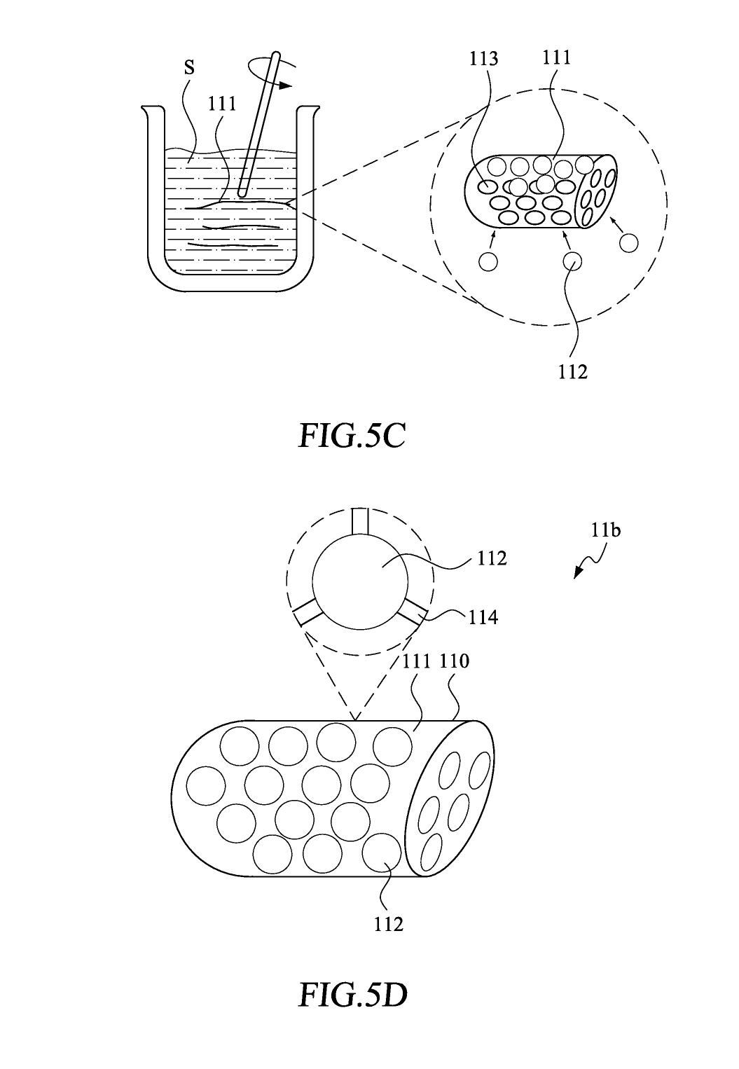

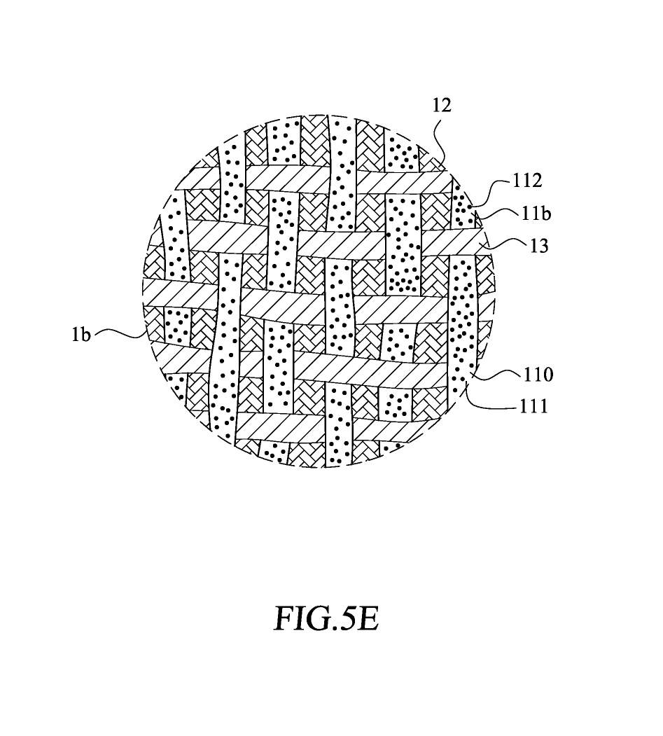

Refer to FIG. 4. First, provide a collagen solution S of which the temperature is 60-70 degrees Celsius (step S1). The collagen solution S is a solution containing the collagen 112 dissolved therein as shown in FIG. 5A. Next, as show in FIG. 5B, dip the fiber 111 in the collagen solution S (step S2). In this embodiment, the fiber 111 is a rayon fiber. The fiber 111 also can be other fiber, such as cotton fiber, linen fiber, nylon fiber, or wool fiber. As show in FIG. 5C, stir the collagen solution S (step S3) to generate a bond 114 between the collagen 112 and a bonding part 113 of the fiber 111 that makes the fiber 111 and the collagen 112 bond with each other, and so that the fiber with collagen 110 is formed and then forming a first fiber component 11b, as show in FIG. 5D.

After forming the first fiber component 11b, dry the first fiber component 11b (step S4) for following textile process. This step is not necessary and can be omitted in some conditions. And then combine the first fiber component 11b, the second fiber component 12, and the third fiber component 13 by textile spinning to form the textile member 1b (step S5), as show in FIG. 5E. In this embodiment, the second fiber component 12 is an elastic Lycra fiber and the third fiber component 13 is a nylon fiber, thereby the elasticity of the textile member 1b and the pull resistance of the textile member 1b both increase. Of courses, this step is not necessary and also can be omitted.

And then combine a plurality of textile members 1b to form the textile component 100b (as show in FIG. 3) (step S6). By means of the steps mentioned above, the textile component 100b which functions as collagen can be formed. The textile component 100b is elastic and tensile so it can contact the skin closer with the more obvious efficacy of collagen. Note in the steps mentioned above, the ambient temperature and the temperature for ironing the textile component can't be larger than 110 degrees Celsius in order to prevent the collagen within the textile component from being damaged.

The garment, pants, and tights are taken as the example as the textile component in above embodiments. However, the present invention is not limited to those examples. The sleeve, hat, mouth mask, eyeshield, face shield, hoods, personal clothing, and all kinds of socks also can be made of the textile component.

As can be appreciated from the above embodiments, the textile component with collagen of the present invention has industry worth which meets the requirement for a patent. The above description should be considered as only the discussion of the preferred embodiments of the present invention. However, a person skilled in the art may make various modifications to the present invention. Those modifications still fall within the spirit and scope defined by the appended claims.

1. A textile component with collagen, the textile component comprising a plurality of textile members, wherein the textile member includes:
a first fiber component composed of a fiber with collagen; and
a second fiber component without any fiber with collagen, the outer surface of the first fiber component and the outer surface of the second fiber component contacting each other along the length direction of the first fiber component by textile spinning,
wherein the fiber with collagen includes a collagen and a fiber, and the collagen bonds with the fiber at a bonding part of the fiber.

2. The textile component with collagen as claimed in claim 1, wherein the second fiber component includes an elastic fiber.

3. The textile component with collagen as claimed in claim 1, wherein the first fiber component and the second fiber component combine with each other by textile spinning, wherein the proportion between the first fiber component and the second fiber component is 1:1.

4. (canceled)

5. The textile component with collagen as claimed in claim 1, wherein the collagen bonds with the fiber by dipping the fiber in a collagen solution of which the temperature is 60-70 degrees Celsius and then stirring the collagen solution.

6. The textile component with collagen as claimed in claim 1, wherein the first fiber component has 8%-10% collagen thereof.

7. The textile component with collagen as claimed in claim 1, wherein the textile member has less than 3% collagen thereof.

8. The textile component with collagen as claimed in claim 1, wherein the fiber is a rayon fiber.
